(19) United States
(12) Patent Application Publication
(10) Pub. No.: US 2012/0246295 A1
(43) Pub. Date: Sep. 27, 2012

(54) Real Time Distribution of Layered Communication Using Publish-Subscribe Data-Centric Middleware

(75) Inventors: Hector H. Gonzalez-Banos, Mountain View, CA (US); Robert Martin Wolff, San Jose, CA (US); Manjesh Malavalli, Sunnyvale, CA (US)

(73) Assignee: XVD TECHNOLOGY HOLDINGS LIMITED, Shannon (IE)

(21) Appl. No.: 13/071,710

(22) Filed: Mar. 25, 2011

(51) Int. Cl. G06F 15/173; G06F 15/16

(52) U.S. Cl. 709/224; 709/228; 709/231

(57) ABSTRACT

Methods and apparatus, including computer program products, implementing and using techniques for organizing a communication session between two or more media aware network entities in a computer network. A computer network includes several media aware network entities (MANEs). The MANEs include data writers and data readers. A model for communication between the MANEs is provided. The communication model includes: subsets of planes associated with a session between two or more MANEs in a domain, each plane representing a collection of MANEs partaking on a subset of topics within the domain; a complementary subset of planes common to all participating MANEs of a domain, an aggregation of domains and topics, and methods for addressing namespaces within the topics. Data streams are exchanged in a session between two MANEs in the computer network according to the communication model. Techniques for distributing a data stream in a computer network are also described.

### CROSS-REFERENCE TO RELATED APPLICATIONS

This application is related to U.S. patent application Ser. No. 13/025,128, filed on Feb. 9, 2011 and titled “Overlay Network,” the entire content of which is incorporated herein by reference.

### BACKGROUND

The present invention relates to multimedia and telecommunications technology, and more specifically, to publish-subscribe and data-centric designs for the distribution of video, audio, chat, and other data streams.

Video conferencing software today leverages a protocol centric architecture, in which the signaling function might be accommodated in accordance with, for example, the H.323 standard, the Extensible Messaging and Presence Protocol (XMPP; previously named “Jabber”), or the Session Initiation Protocol (SIP). Quality of service is managed by protocols such as the Resource Reservation Protocol (RSVP) and the Real-Time Transport Control Protocol (RTCP). Media is transported with protocols such as the H.261 standard, Moving Pictures Expert Group (MPEG) compression technology, and Real-time Transport Protocol (RTP).

A consequence of having these diverse protocols is that there is often limited or awkward interoperability between these various protocols, and often less flexibility within each of the major functional sections of signaling, quality of service, and media transport. In addition the extension of video conferencing to other media sources, such as streaming data, multiple video sources, scalable video, scalable media, and screen sharing, to name just a few, must integrate in an ad-hoc proprietary manner.

### SUMMARY

According to one aspect of the present invention, methods, apparatus, and systems, including computer program products, are provided for organizing a communication session between two or more media aware network entities in a computer network. A computer network is provided. The computer network includes several media aware network entities. One or more of the media aware network entities includes several data writers and several data readers. A communication model for communication between the media aware network entities is provided. The communication model includes several subsets of planes, a complementary subset of planes, an aggregation of domains and topics and a method for addressing namespaces within the topics. Each subset of planes is associated with a session between two or more media aware network entities. The session is contained in a distinct domain. Each plane represents a collection of media aware network entities partaking on a subset of topics within the domain. The complementary subset of planes is common to all participating media network entities of a domain. One or more data streams are exchanged in a session between a first media aware network entity and a second media aware network entity in the computer network in accordance with the communication model.

Various implementations can include one or more of the following features. Several sessions can be present simultaneously in the computer network and a distinct set of media aware network entities can be associated with each session. Each session can be associated with a distinct subset of media planes, control planes and administration planes, and the complimentary subset of planes can include a domain administration plane that is common to all participating media aware network entities of a domain. The one or more data streams can be supported by the media plane and can be managed as topics to which a data reader can subscribe. An administration plane can be associated with each session and a domain administration plane can be shared between all media aware network entities of a domain.

One session can map to a single domain, or a domain can contain multiple independent sessions. There can be one media plane per media component per media aware network entity publishing in a session. There can be one media plane per media aware network entity publishing in the session, the media plane containing all the media components published by the media aware network entity. There can be one media plane for all components for all media aware network entities publishing in a session.

A topic nomenclature and namespace rules can be provided to each media aware network entity joining a session, wherein the topic nomenclature and namespace rules characterize the planes in the subset of planes associated with the session and the planes in the complementary subset of planes. The topic nomenclature and namespace rules can include a first portion and a second portion. The first portion of the topic nomenclature and namespace rules can be used by the media aware network entities joining a session to exchange information about the second part of the topic nomenclature and namespace rules with other media aware network entities joining the session. The first portion can include the complementary subset of planes.

The first portion of the topic nomenclature and namespace rules can be hardcoded in the media aware network entity logic. The first portion of the topic nomenclature and namespace rules can be provided and updated by a supervisory central service. The topic nomenclature and the namespace rules can be hardcoded in the media aware network entity logic. The topic nomenclature and the namespace rules can be provided by a supervisory central service. Providing topic nomenclature and namespace rules can include accessing, by each media aware network entity joining a session, the topic nomenclature and namespace rules using a hardcoded topic in a plane known to the media aware network entities.

The topic nomenclature and namespace rules can be updated to define a different configuration of planes in the subset of planes associated with the session and a different configuration of planes in the complementary subset of planes. Two simultaneous sessions in a same domain can have different plane arrangements, where the plane arrangement for each session is defined by a distinct set of topic nomenclature and namespace rules.

According to one aspect of the present invention, methods, apparatus, and systems, including computer program products, are provided for distributing a data stream in a computer network. A computer network is provided. The computer network includes several interconnected media aware network entities in a publish-subscribe framework. One or more of the media aware network entities includes several data writers and several data readers. The data stream is published by the data writers in a first media aware network entity. Each data writer among the data writers in the first media aware network entity can publish a specific layer of the data stream. A data reader in a second media aware network entity subscribes to the data stream published by one or more of the data writers in the first media aware network entity.

Various implementations can include one or more of the following features. The media aware network entities can further include logic for one or more of: network adaptation, data stream transformation, and data stream recording. A media aware network entity can transform the incoming data stream from the first media aware network entity from a first format to a second format and retransmit the data stream in the second format to a different media aware network entity. Transforming the incoming data stream can include transcoding from a first protocol to a second protocol, transcoding from a first format to a second format, translating from text to speech, translating from speech to text, translating from a first language to a second language, or extracting metadata from the data stream for use in a different media aware network entity.

A media aware network entity can record the incoming data stream from the first media aware network entity for future processing or storage. A media aware network entity can play back the recorded data stream. The media aware network entities can be customized based on network topology, location, or hardware capability. The data stream can include data representing video, audio, chat, financial market data, radar data, telemetry, telecommands, teleprescence data, haptics measurements, or telemedicine data. Each data writer in a first media aware network entity can publish its layer of the data stream in a media plane among several planes that are associated with a session between the first and second media aware network entities; and the data reader in the second media aware network entity can subscribe to a subset of media planes, which subset collectively defines a quality of the data stream to which the second media aware network desires to subscribe. Each media plane can contain data published by two or more data writers. Each media plane can contain one or more topics to which the data reader can subscribe. Each data writer in a media plane can correspond to one media aware network entity.

The data reader in the second media aware network entity can detect whether there are irregularities in the data stream sent from the data writer in the first media aware network entity; and can subscribe to a different subset of data writers from the first media aware network entity if irregularities or improved network conditions are detected. Detecting the irregularities can include detecting data packets in the data stream that arrive at the data reader in a different order compared to the order in which the data packets were transmitted by the data writer, or detecting lost data packets in the data stream received by the data reader. Detecting improved network conditions can include detecting decrease in rate of lost or corrupted data packets.

If irregularities in the data stream are detected, invalid or redundant data packets can be discarded, the received data packets can be renumbered and the renumbered data packets can be transmitted to a data reader of a different media aware network entity. Subscribing to a different subset of data writers can start when irregularities in the data stream has been detected during a time window that is based on a frame rate for the data stream, or a time slice period for packets in the data stream.

Various implementations can include one or more of the following advantages. A publish/subscribe approach allows participants to be ignorant of the network topology since the focus can be the subscription to the actual media components within a communication session. Publishers are loosely decoupled from subscribers allowing for greater scalability and dynamic topology. Layered media such as the scalable video encoding described in the Annex G extension of the H.264/MPEG-4 AVC video compression standard can be supported by using multiple data writers under the same publisher. Adaptation to network conditions can be done by subscribing or unsubscribing to non-critical layers, or varying the Quality of Service (QoS) offered by a publisher. Network topology can be changed by adding relay/proxies, or even redundant publishers. A data-centric approach allows flexible management of communication domains, sessions and media resources. Data-centricity also allows new media formats or extensions to be easily added in a backward-compatible manner. The adjustment of the data subscriptions can occur without resorting to a central authority if simplicity and distributed functionality is desired.

The details of one or more implementations of the invention are set forth in the accompanying drawings and the description below. Other features and advantages of the invention will be apparent from the description and drawings, and from the claims.

### DESCRIPTION OF DRAWINGS

FIG. 1 shows a communication system (100) in accordance with one implementation.

FIG. 2 shows a schematic diagram (200) of the communication and administration mechanism for the MANEs in FIG. 1, in accordance with one implementation.

FIG. 3 is a schematic view of the data centric management of connections between MANEs into applications, in accordance with one implementation.

FIG. 4 is a schematic view of a system (400) in which a set of participants partakes in a videoconference session, in accordance with one implementation.

FIG. 5 is a schematic diagram of how scalable video is sent between MANEs within a domain, in accordance with one implementation.

FIG. 6 is a schematic view of how encoded source video is sent from a source MANE to a client MANE, in accordance with one implementation.

FIG. 7 is a schematic view of a two-layer overlay network in which MANEs can be instantiated, in accordance with one implementation.

Like reference symbols in the various drawings indicate like elements.

### DETAILED DESCRIPTION

### Overview

In a first general aspect, the various implementations of the invention are directed to techniques for distributing video (scalable as well as non-scalable) and accompanying data streams, such as chat, audio, screen sharing, real time data streams, etc. using a data centric publish subscribe framework such as the Data Distribution Service (DDS) for Real-time Systems specification, which is a specification for publish/subscribe middleware for distributed systems, developed by the Object Management Group (OMG).

In another general aspect, the systems in accordance with the various implementations described herein can be described as having four conceptual components. First, a data model containing planes for media, control, administration; an aggregation of domains and topics; and a method for addressing namespaces within the topics. Second, a set of Media Aware Network Elements (MANEs), where each MANE contains a set of data readers that allows the MANE to subscribe to data streams, a set of data writers that allows the MANE to publish data streams, and logic for network adaptation and/or data stream transformation and/or recording. Third, network adaptation within the MANEs that can detect missing packets, or packets that arrive too slowly, and can that adjust the data stream accordingly including renumbering the packets in the data stream and eventually eliminating entire levels of the subscription, if possible. Fourth, presence and negotiation that leverages the self discovery mechanisms of the DDS infrastructure, and well known topics for support of directory services such as discovering a person, or notifying that person. Each of these conceptual components will be described in detail below.

In another general aspect, the systems in accordance with the various implementations described herein are composed of participants who may be physical persons, or which may be computer processes that act as a single entity. Each participant can have multiple sources, for example, video streams from cameras or screen capture, audio, chat, embedded sensor data, or real time data streams like financial information. Each source may be scalable, such that a meaningful subset of the source could be delivered to other participants to accommodate bandwidth and other network considerations. For example, as will be described in further detail below, there can be one data writer per layer per service per participant.

In another general aspect the tuning of the overall quality of service occurs by subscribing or unsubscribing to various data writers. Further, in one implementation the MANE may observe missing packets of data based on the numbering scheme of the packets. The MANE may contain instructions, for example, to wait one over the time slice or one over the frame rate to discard the missing packets. Taking note of the frequency of discard, a receiving MANE may signal to a sending MANE that it wishes to unsubscribe from some data writers to lower the burden on the computer network. Further when sending the packets on to the next MANE, it will re-number the packets so that the next MANE does not notice that there are missing packets. Furthermore, by renumbering packets, the location of data loss may be quickly ascertained.

In another general aspect MANEs are divided such that each MANE is connected in a directed graph, or in a rooted tree configuration. In the preferred implementation, there is one MANE per physical source, although in some implementations this requirement may be relaxed at the expense of loosing conceptual simplicity.

In another general aspect, a MANE may transform its data stream. This includes, but is not limited to entities transcoding from one protocol to another, transcoding from a first format to a second format, translating from text to speech, translating from speech to text, translating from one language to another, extracting meta-data from the data stream for use in another entity such a gathering data for machine learning applications, extracting meta-data from a data stream for use in populating an ontology. In another general aspect a MANE may retain a data stream, in effect recording the data stream for future playback or processing.

In another general aspect the typical discovery mechanism for the data centric publish subscribe mechanism is extended from the Local Area Network (LAN) to the Wide Area Network (WAN), or the Internet. This is accomplished through the use of shared peer lists that a participant may subscribe to. The peer lists are made available through shared subscriptions in a central control plane.

As will be appreciated by one skilled in the art, aspects of the present invention may be implemented as a system, method or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages, or declarative languages and domain-specific languages such as the Lua programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Various implementations of the invention are described below with reference to flowchart illustrations and/or block diagrams of methods, apparatus (systems) and computer program products according to implementations of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### Exemplary Communication System

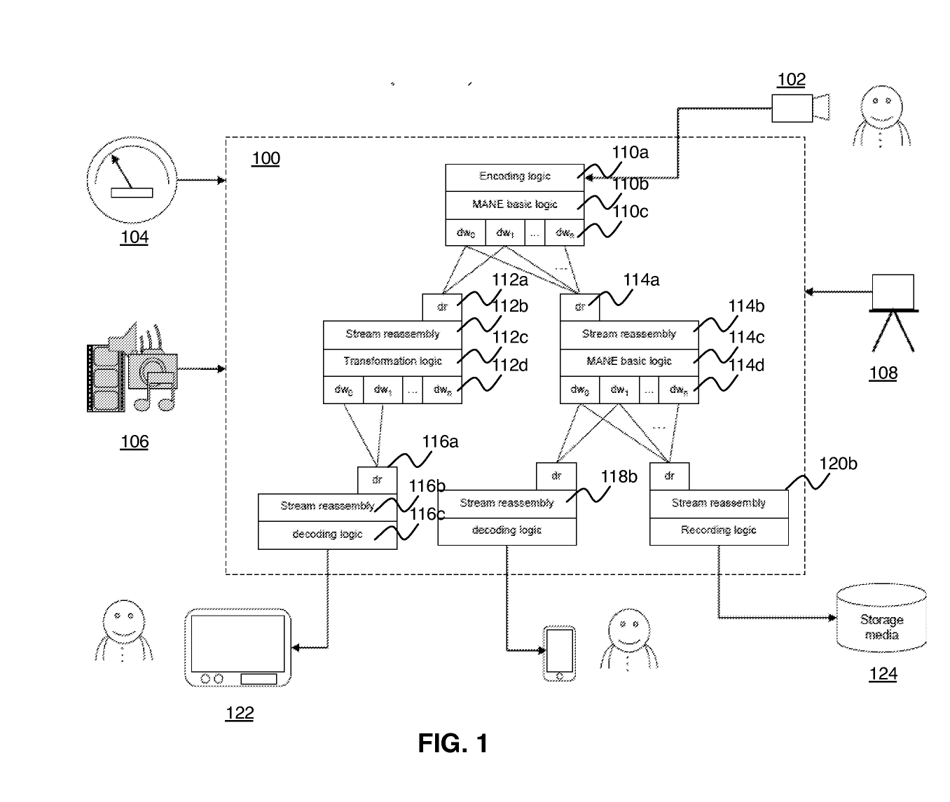

A communication system (100) in accordance with one implementation will now be described by way of example and with reference to the figures. In the illustrated implementation, the communication system (100) is a layered communication system that incorporates publish/subscribe mechanisms. As can be seen in FIG. 1, the system (100) can include a variety of devices, such as a video camera (102), a sensor (104), a streaming multimedia device (106), a computing device containing a document (108), etc., just to mention a few examples. In the illustrated implementation, the video camera (102) is functionally connected to a MANE (110) through a computer network, such as the Internet or an intranet.

Various aspects of the MANEs will be described in further detail below, but for the purposes of the system illustrated in FIG. 1, a MANE in a general sense can be described as a network element that based on the content of the data stream modifies its networking or relaying behavior in some way. In the implementation shown in FIG. 1, the MANE (110) that is connected to the video camera (102) contains encoding logic (110a) for the video camera (102). The central process that creates this MANE (110) uses the information from a requesting application or underlying supervisory service to determine the appropriate functionality for the MANE (110) and the MANE (110) is instantiated appropriately. In general, the all devices have MANEs with appropriate encoding logic for the respective device. As the skilled person realizes, the devices shown in FIG. 1 are indicative of typical devices that might connect to the system (100) in various implementations, but should not be considered to be an exhaustive selection of devices. Many other devices can also be used in the system (100) for various purposes.

In addition to the encoding logic (110a), the MANE (110) contains additional logic (110b) that may vary depending on the desired functionality of the MANE (110). The MANE (100) also contains several data writers (110c), referred to as dw0, dw1, dwn, in FIG. 1. A raw data stream comes into the MANE (100) from the video camera (102), gets encoded into an encoded media stream by the encoding logic (110a). Each data writer (110c) then sends a layer of the encoded media stream on to a further MANE, illustrated in FIG. 1 by MANEs 112 and 114. A layer of a media stream is in the general sense a subset of the stream representing a set of media features, quality aspects, or media enhancements that can be discarded without preventing decoding of the rest the media stream. An example is the scalable video encoding described in the Annex G extension of the H.264/MPEG-4 AVC video compression standard. For simple protocols that do not break down into scalable layers, only one layer is published, resulting in only one data writer (e.g., dw0) being used.

In FIG. 1, one of the receiving MANEs (112) only subscribes to a subset of the available data writers, dw0 and dw1, as shown. In the illustrated implementation, a data reader (112a) in MANE (112) is paired only with those data writers to which it subscribes. The other receiving MANE (114) subscribes to all the data writers, dw0, dw1, dwn, of MANE 110, using its data reader (114a). In the implementation illustrated in FIG. 1, the MANEs are connected in a directed rooted tree, as shown by MANEs 110, 112, 114, 116, 118 and 120. In general, a network of MANEs implements a graph, including directed graphs and rooted trees. Acyclical communication paths between media sources and information recipients can be guaranteed by the use of directed rooted trees.

In general, MANEs have several data writers and a single data reader, as shown in FIG. 1. However, it should be noted that this is not a requirement and that there are other implementations in which there may be any combinations of single or multiple data readers and single or multiple data writers. Furthermore, as shown in FIG. 1, the MANEs generally contain logic (112b, 114b, 116b, 118b and 120b) for reassembling an incoming data stream. The MANEs can also contain various types of logic (112c) for transformation of a data stream before the data stream is forwarded to a subsequent MANE (116) or to an end point through the use of one or more data writers (112d).

For example, MANE 112 contains transformation logic (112c) for transcoding from a first media stream format encoding by the camera, to a second media stream format encoding, for consumption by a tablet-type device (122). A data reader (116a) of MANE 116 receives the media streams from two data writers (112d) of MANE 112. The stream reassembly logic (116b) of MANE 116 reassembles the received media stream, decodes the reassembled media stream by using decoding logic (116c), and finally forwards the decoded media stream for display on the tablet-type device (122). Thus, as can be seen in the implementation illustrated in FIG. 1, for two devices (102, 122) to connect there are at least two MANEs (110, 116) (and possibly more MANEs, such MANE 112) to broker unidirectional data transfer from the video camera (102) to the tablet-type device (122). In some implementations, data streams traveling in the opposite direction (e.g., control data traveling from the tablet-type device (122) to the video camera (102)), are handled by two additional MANEs (not shown in FIG. 1 for reasons of simplicity).

Furthermore, as can be seen in FIG. 1, in the case of MANE 114, its data reader (114a), stream assembly logic (114b), base logic (114c), and data writers (114d) simply pass the data stream received from the data writers (110c) of MANE 110 through to MANE 120. The central process that is responsible for the creation of MANE 114 considers factors such as network topology, location, and hardware capability when creating the MANE (114). The receiving MANEs 118 and 120 each subscribes to a subset of data writers (114d) of MANE 114, which are appropriate for the bandwidth the data writers (114d) are able to support. MANE 120 is a MANE that reassembles a data stream for recording the assembled data stream on some type of storage medium (124). Having this conceptual image in mind of the interaction and capabilities of the MANEs, further details about the communication between the MANEs will now be described.

### Communication Between MANEs

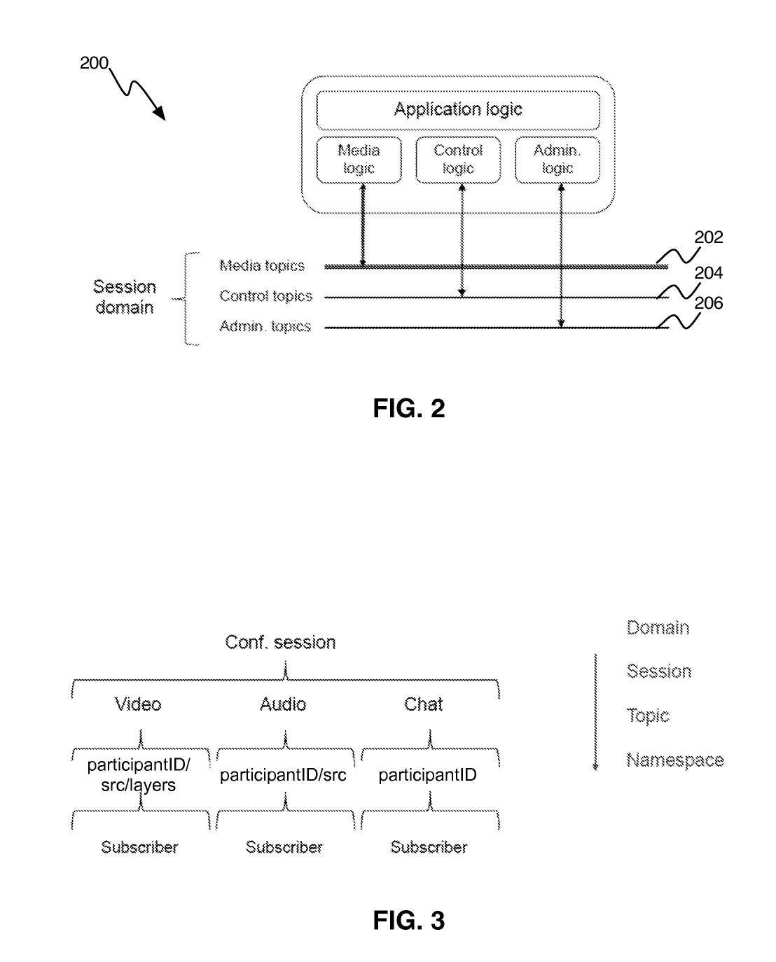

FIG. 2 is a schematic diagram (200) showing the communication and administration mechanism for the MANEs in FIG. 1. These mechanisms allow support of large numbers of devices communicating with many end points through a number of MANEs assembled in essentially any type of graph structure, such as the rooted tree structure shown in FIG. 1. The MANEs communicate with other MANEs in the larger system through the use of planes. A plane is collection of participants partaking on a subset of topics within a domain. Before describing the use of planes in further detail and to facilitate the understanding of the concept, a brief description of the data centric management of communications between MANEs will be provided with reference to FIG. 3.

FIG. 3 shows a schematic view of the data centric management of connections between MANEs into applications such as videoconference calling, editing of stored media (e.g., movies), content delivery networks, etc. A conference session between a set of end points that may or may not have humans at each end, such as the video camera (102) and the tablet-type pad (122) of FIG. 1, takes place within a domain as labeled. There may be a single or several sessions occurring simultaneously within a domain. The various media types, for example, video, audio, and chat, as illustrated in FIG. 3, are represented as topics within the domain of the publish-subscribe framework. The OMG Data Distribution Service (DDS) provides mechanisms for defining Domains and Topics.

In order for a data reader to subscribe to a particular data writer in a MANE, the system also includes the concept of a namespace. A namespace is a context for the identifying and addressing data writers. The concept is akin to the way file folders are addressed in conventional computer systems (in fact, a file directory in an operating system is an example of a namespace). For example, OMG Data Distribution Service (DDS) provides partitions to define namespaces within domains. It should be realized that there are multiple options of achieving this addressing and that the implementation shown in FIG. 3 is presented here merely for illustration purposes.

In FIG. 3, a domain contains a single communication session where the participating MANEs are organized into three topics: ‘video’, ‘audio’ and ‘chat’. The MANES under the topic ‘video’ are further organized by participant id, source id, and the layer number. The MANEs under topic ‘audio’ are further organized by participant id and source id. For the topic ‘chat’ they are further organized only by participant id. In order to pair a data reader with the data writers within a video publisher it is a simple matter of subscribing to the general topic ‘video’, and specifying the participant id, the video source of interest (in case multiple distinct sources are available from the participant), and the desired layers (e.g.; {all}, {0-20}, {0-5}, {0,2,4}, etc.). In the case of media that does not contain multiple layers, as the case may be for audio (although it should be noted that audio may in some implementations contain multiple layers), the subscription is done to the topic (e.g., ‘audio’) and only the participant id and source id are specified, as shown in FIG. 3. For the case of media that neither contains multiple layers nor multiple sources, such as chat, only the participant id is specified under subscription to the topic ‘chat’. With this in mind, returning now to FIG. 2, planes (i.e., collections of participants partaking on a subset of topics within a domain) serve to keep topics and participants in separate logical compartments. Media streams between participants in a session can then be organized into media planes (202) and can include content such as audio, video, chat, and other types of streaming data. Planes are implemented using topics and namespace rules (or partition rules for the specific case of OMG DDS). Every data writer is a member of a plane and can be addressed within the plane by a data reader. Data readers within a MANE can henceforth subscribe and receive the data stream of their interest, as described above. In some implementations, the list of topics and namespace rules is maintained by the MANE itself, but it should be realized that there may also be other implementations in which a central list of topics and their associated namespace rules are themselves propagated to all MANEs from a central repository using a well-known and a priori topic.

There are multiple ways to organize a communication session with planes. In one implementation, a topic ‘session<#sid>_media’ is used to contain all the media components exchanged between all participants in the session numbered #sid (the use of < > denotes one-to-one conversion from number value to alphanumeric string). All data writers under this topic can be further addressed using a partitioning rule of the form /<#pid>/mtype/<#src>/{layers} where #pid denotes the participant number, mtype is the media type (e.g., ‘video’, ‘audio’, etc.), #src is the source number, and {layers} the list of desired layers. This topic and namespace arrangement implements a conferencing system where a single media plane contains all the media components involved in a session.

In another implementation, multiple topics of the form ‘session<#sid>_participant<#pid>_media’ can be defined, where again #sid denotes the session number and #pid the participant number. All data writers under these topics can be further addressed using a partitioning rule of the form /mtype/<#src>/{layers}. This arrangement implements a conferencing system where there is one media plane per participant publishing media in the session, and where the media plane contains all the media components published by the participant.

In yet another implementation, multiple topics of the form ‘session<#sid>_participant<#pid>_mtype’ can be defined, which now include the media type mtype (e.g., ‘video’, ‘audio’, etc.). These topics can be further addressed using a rule of the form /<#src>/{layers}. This arrangement implements a conferencing system with one media plane per media component per participant publishing in a session.

In some implementations, a control plane (204) is provided to contain topics such as ringing, session management, initiation of a call, invitation of participants, and session tear down. Similar to the media plane (202), the topics of the control plane (204) can be maintained by the MANE itself, or can be centrally managed.

In some implementations, such as the one shown in FIG. 2, an administration plane (206) is provided. The administration plane (206) can contain non-operational functions, such as diagnostics and maintenance, for example. Just like in the media plane (202) and the control plane (204), these non-operational functions are represented as topics of the administration plane (206).

In other implementations (not shown), the planes can be configured such that different administration planes (206) exist for each session, and a further domain-administration plane is shared for all members of a domain. Thus, in the most general case, there will be several of subsets of planes, where every subset is associated with a different session, and there is also a complementary subset of planes that are common to all participants in a domain.

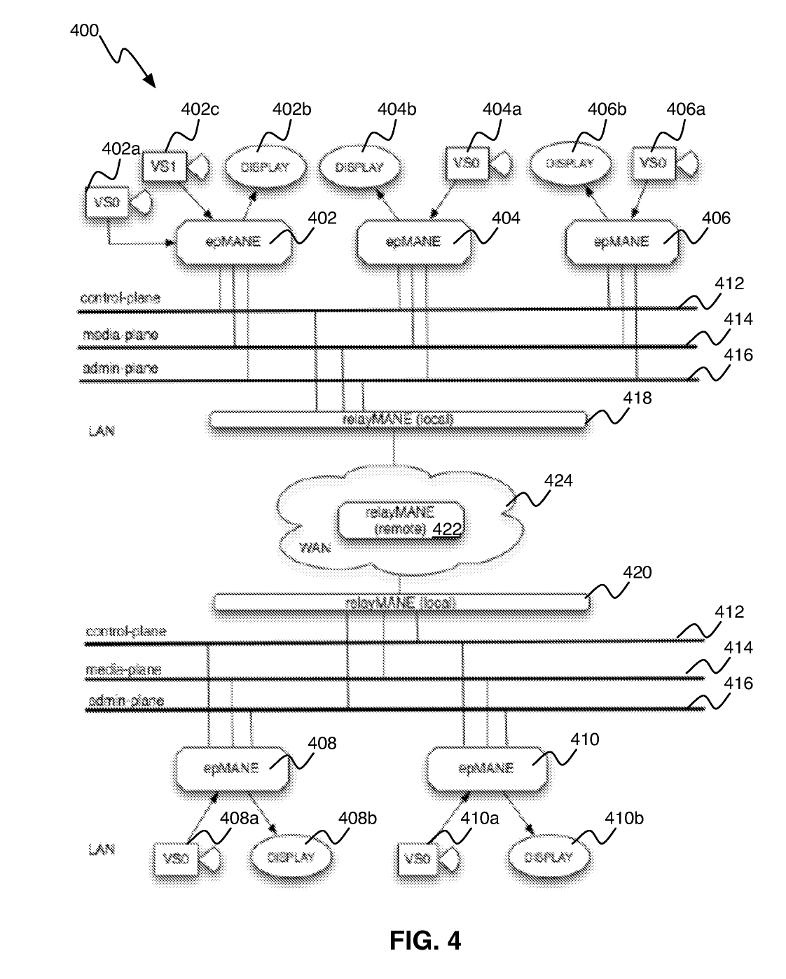

FIG. 4 is another schematic view showing a system (400), in which five participants, represented by MANEs 402, 404, 406, 408 and 410, partake in a video conference session. Each MANE has at least one associated video camera (402a, 402c, 404a, 406a, 408a, 410a) and a display (402b, 404b, 406b, 408b, 410b). MANEs 402, 404 and 406 are connected to a first LAN, and MANEs 408 and 410 are connected to a second, remotely located LAN. In accordance with the above discussion, a media plane (412), a control plane (414), and an administration plane (416) is used to organize the session between the MANEs (402, 404, 406, 408, 410). In order to relay the data streams between the LANs, two relay MANEs (418, 420) are provided, one on each LAN. The relay MANEs (418, 420) communicate through a remote MANE (422) in a WAN (424). By arranging the system (400) in this manner, any video camera video camera (402a, 402c, 404a, 406a, 408a, 410a) can communicate with any display (402b, 404b, 406b, 408b, 410b) either in a closed session that is limited to a certain set of participants only, or in an open session which any participant may join as they log onto the system (400).

### Network Connectivity

Network connectivity between MANEs can be achieved through various standardized network protocols. The simplest example is a local area network (LAN) where all MANEs are hosted in machines that can establish connections with each other. A challenging situation can arise when MANEs are hosted in machines that are located in different private networks and that lack global Internet Protocol (IP) addresses. Private networks are typically isolated by firewall devices using Network Address Translation (NAT) to modify the address information in IP packet headers while in transit to the Internet. In such a scenario, standardized methods such as Interactive Connectivity Establishment (ICE) protocol, the Session Traversal Utilities for NAT (STUN) protocol, and Traversal Using NAT (TURN) can be used for NAT and firewall traversal (see Networking Working Group RFC 5389).

For the purpose of this description, it is assumed that connectivity can be achieved by a network transport mechanism of some sort, where the network transport mechanism is independent of the publish-subscribe middleware. For the case involving private networks and NAT, possible transports are Ntop's layer 2 peer-to-peer VPN, open source JXTA, or RTI's Secure WAN transport. Other transports are also possible.

### Presence and Setup of Sessions

Domain participants need information about available participants. The information about a participant can include the participant's connectivity status, disposition to interact, geographical location, credentials, membership privileges, etc. This information is referred herein as “presence information,” or simply “presence.” The network service managing and distributing presence information is referred as the “presence service.” Presence is a common characteristic of most communication systems, and it is a separate issue from establishing a communication session.

Presence information can be distributed in a centralized manner. In one implementation, domain participants can connect to a presence service and periodically receive presence information updates. In another implementation, presence information can be encoded using Extensible Markup Language (XML).

Presence information can also be distributed in a non-centralized manner. In one implementation, domain participants subscribe to a ‘presence’ topic within a domain-administration plane. Every domain participant publishes its presence information and becomes available to every other domain participant.

Beyond presence, establishing a communication session involves agreement between participants about the topic names and namespace rules characterizing the planes underpinning the session. A topic naming scheme or system is referred herein as a “topic nomenclature.” Establishing a communication session is a matter of conveying to the participants of the communication session the topic nomenclature and namespace rules of the communication session. In one implementation, the topic nomenclature and namespaces rules for a session can be encoded using the Extensible Markup Language (XML).

In one implementation, the topic nomenclature and namespace rules can be hardcoded into the MANEs' logic. In another implementation, the topic nomenclature and namespace rules can be provided by a supervisory central service. In yet another implementation, session participants can exchange information about topic nomenclature and namespace rules using hardcoded topic within a well-known plane.

In a broader sense, the topic nomenclature and namespace rules can be described as having two parts. The first part is either hardcoded into the MANEs' logic or regularly updated by a supervisory central service. The first part is then used by the participants to exchange information about the second part. In one implementation, the first part defines a list of known topics for all domain participants. Once a session is established, the participants use the known topics to propagate discovery information about the available publishers and subscribers and associated topics within a session.

Sessions in the same domain can use different topic nomenclatures and namespace rules. Thus, there can be different planar arrangements within sessions. It is then possible to select the most appropriate arrangement for the objective of the session. For example, a session for distance learning can have a different planar arrangement from that of a multiparty video conferencing.

Once a session is established, it may be necessary to convey specific information about media formats, language settings, available computing resources, display size, geographical location, etc. In some implementations, the negotiation for capabilities and resources for specific applications are implemented as topics in the system. For example, in the case of videoconference, a media description topic within a control plane can describe the available audio and visual codecs, and another topic within the same control plane can describe the available computing resources and display size. In a sensor network application, a ‘geotype’ topic may communicate the type and geographical location of the sensor. In a content distribution application, the digital rights management may be handled with topics specific to digital rights distribution.

### Adaptation to Network Congestion

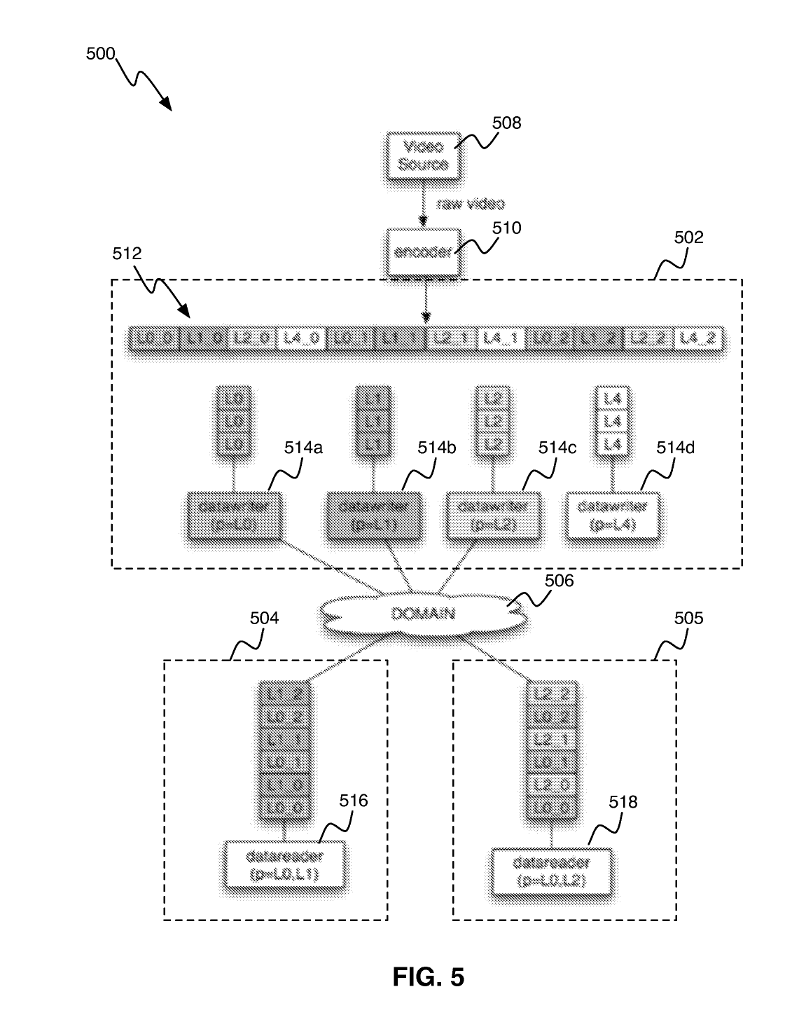

FIG. 5 shows a schematic diagram (500) of how scalable video is sent from a first MANE (502) to a second MANE (504) and a third MANE (505) in a domain (506), in accordance with one implementation. As can be seen in FIG. 5, a video source (508) transmits raw video to the first MANE (502). As was described above, the first MANE (502) encodes the raw video using an encoder (510) into a sequence of packets (512) that can be transmitted to and received by the second MANE (504) and third MANE (505). In one implementation, the packets are labeled with a global Decoding Order Number (DON). As can be seen in FIG. 5, in the encoded video stream (512) the packets are labeled L0.0, L1.0, L2.0, L4.0, L0.1, L1.1, L2.1, L4.1, etc., where L0, L1, L2 and L4, respectively, indicates the layer and the number after the period indicates the respective packet number's placement in the video stream (512).

As was discussed above, each data writer (514a-d) publishes one layer of the video stream (512). For example, as shown in FIG. 5, data writer 214a publishes all the LO packages, data writer 214b publishes all the L1 packages, data writer 214c publishes all the L2 packages and data writer 214d publishes all the L4 packages. Each of the receiving MANEs has a data reader. The second MANE (504) has data reader 516 and the third MANE (505) has data reader 518. Each data reader (516, 518) subscribes to a particular set of data writers (514a-d). For example, as shown in FIG. 5, the data reader (516) of the second MANE (504) subscribes to data writers 514a and 514b to receive layers L0 and L1, and the data reader (518) of the third MANE (505) subscribes to data writers 514a and 514c to receive layers L0 and L2. Thus, each of the second MANE (504) and third MANE (506) can receive a desired set of layers, which set of layers defines a quality of the subscription of the data stream (512) from the video source (508). Due to this “writer-side filtering” of video packets, which occurs by data readers (516, 518) only connecting with their “desired” data writers (514a-d), the unrequested layers of the video stream (512) (in the case of FIG. 5, layer L4) are never transmitted across the network from the first MANE (502) to the second MANE (504) and third MANE (505). As a result, valuable network bandwidth can be preserved.

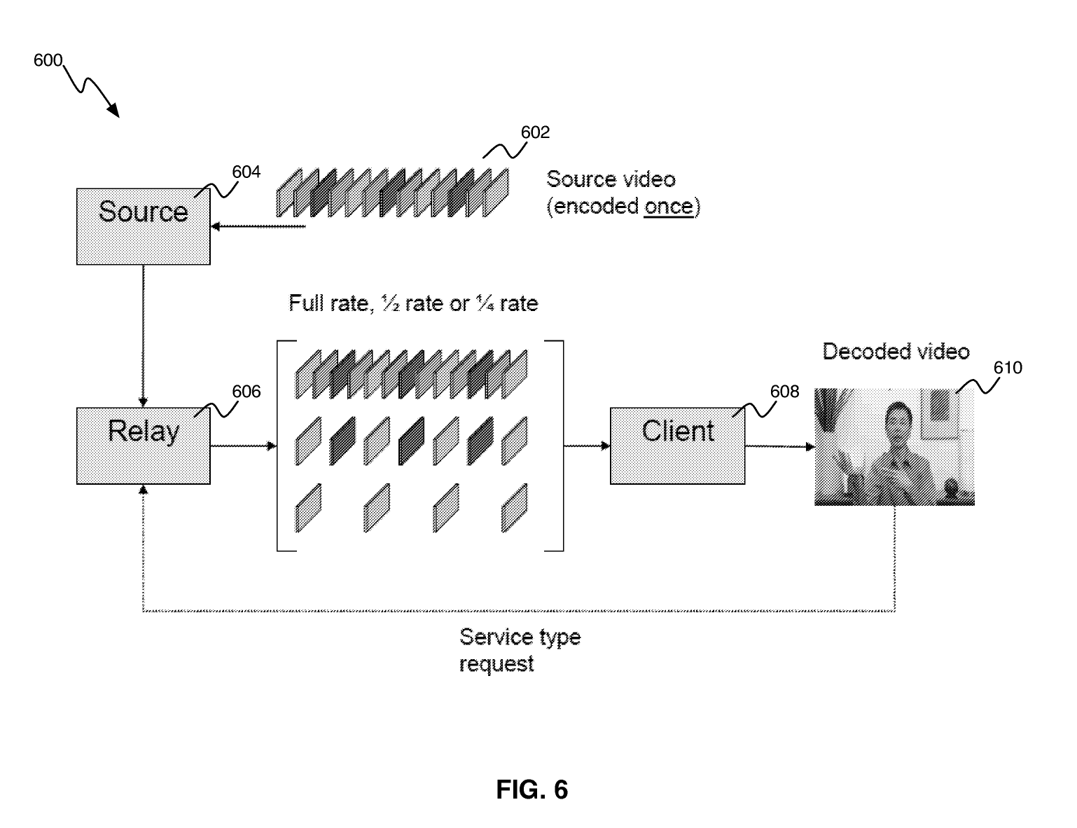

FIG. 6 shows an alternative schematic view (600) of how encoded source video (602) is sent from a source MANE (604), through a relay MANE (606), to a client MANE (608), where the video is decoded and displayed on a display (610). The client MANE (608) can send a service request to the relay MANE (606) specifying the desired frame rate, illustrated in FIG. 6 by the full frame rate, ½ frame rate and ¼ frame rate, respectively, to which it desires to subscribe. Expressed differently, the client specifies which data readers of the relay MANE it wishes to subscribe to. The service request can be sent either as a result of a user of the client device specifying a desired video quality, or in response to the client MANE (608) detecting a decrease in quality of the received packets, for example, as a result of network congestion etc. The decrease in quality or network congestion can manifest itself, for example, by lost packets or packets that arrive out of order, both of which can be identified through the specific DON numbering scheme described above.

In one exemplary implementation, the client MANE (608) adapts to network congestion and failure to receive packets in a timely manner, using the following techniques. The MANE (608) waits one over the frame rate, or one time slice for all packets. Then missing packets are discarded and the remaining ones are re-ordered. Noting the frequency of the discard, if the protocol is layered, the MANE (608) may elect to unsubscribe to one or several of the data writers of the relay MANE (608) feeding its data reader, typically resulting in a decreased frame rate and thus a slightly lower quality of the video transmission.

It should be noted that while the above discussion has been referencing a client MANE (608), the same techniques can be applied to any MANE in a chain of relay MANEs from a source MANE to a destination MANE. Since the MANE with the packet loss issue performs the renumbering in the described implementation, it can send signals over the administration plane, which signals indicate the point of data loss. A supervisory service may then decide whether or not to take remediating action to fix the data loss, for example, with the addition of resources, such as adding further MANEs, etc.

### MANE Network Architecture

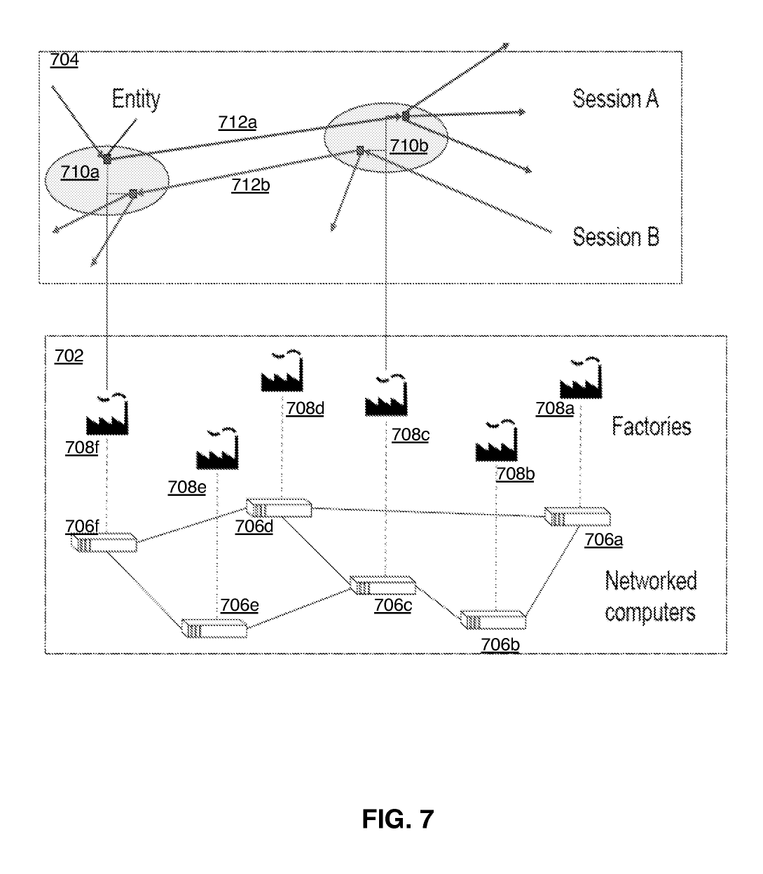

The network of MANEs described above can be realized in many ways. Some of these implementations have been described in co-pending U.S. patent application Ser. No. 13/025,128, which is incorporated above by reference. FIG. 7 shows one implementation, in which the MANEs are implemented in a two-layer overlay network (700) on top of a host network, such as a TCP/UDP network. It should be noted that for reasons of simplicity, only a few components of the network have been illustrated in FIG. 7, whereas in a real life scenario, there may be tens or hundreds of components.

In the implementation illustrated in FIG. 7, the two-layer overlay network (700) is divided into a first layer (702) and a second layer (704). The first layer (702) includes one or more servers (706a-706f). The servers (706a-706f) can be either physical machines or software implementations of machines (i.e., a virtual machines), or a combination thereof. The servers (706a-706f) are connected by means of a network, illustrated in FIG. 7 by interconnecting lines between the servers (706a-706f), so that they can communicate with each other as needed. The servers (706a-706f) can be hosted either on data centers, co-location centers, computer facilities, server rooms, or in a so-called “cloud computing” environment.

Each server (706a-706f) can support one or more dynamically instantiated, maintained and destroyed factories (708a-708f). In the implementation shown in FIG. 7, a factory is a computer program that ordinarily runs as a background process in the hosting server. The factories (108a-108f) can, as a result of receiving an appropriate instruction, create or destroy one or more dynamically instantiated MANEs (710a-710b) in the second layer (704). Factories receive their instructions from dispatch controllers, which also act as nodes in the first overlay network. Dispatch controllers are programmable devices that can execute scripts controlling one or more factories. There can be several dispatch controllers acting in concert to enhance scalability and elasticity.

In one implementation, a server, such as server 706f, creates a factory (708f). The factory (708f) gets paired with a dispatch controller and waits for further instructions. A dispatch controller communicates with its factories under a master-slave arrangement with the dispatch controller as master. As the controller executes a script, it may direct a factory to create, delete or migrate entities.

Upon receipt of the instruction, the factory (708f) creates a new MANE (710a). In one implementation, the factory spawns entity managers to handle groups of entities. These entity managers run either as stand-alone programs or threads within a factory. MANEs are spawned by the entity managers and run as threads. A factory communicates with the entity managers using a master-slave arrangement with the factory as master. A factory can monitor the computational resources used by itself, by the entity managers, and by other programs sharing the same server. Entities communicate network conditions to the factory through the entity managers using event-based messaging.

Further details about this and other implementations can be found in U.S. patent application Ser. No. 13/025,128. In addition, as the skilled reader realizes, there are many other types of middleware that can be used to implement MANEs that can operate as described above. For example, middleware such as RTI DDS, OpenSplice, OpenDDS can also be used to implement the same or similar MANE functionality.

### Concluding Comments

The terminology used herein is for the purpose of describing particular implementations only and is not intended to be limiting of the invention. As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementations were chosen and described in order to best explain the principles of the invention and the practical application, and to enable others of ordinary skill in the art to understand the invention for various implementations with various modifications as are suited to the particular use contemplated.

1. A computer-implemented method for organizing a communication session between two or more media aware network entities in a computer network, comprising:
providing a computer network, the computer network including a plurality of media aware network entities, wherein one or more of the media aware network entities includes a plurality of data writers and a plurality of data readers;
providing a communication model for communication between the media aware network entities, the communication model including:
a plurality of subsets of planes, wherein each subset of planes is associated with a session between two or more media aware network entities, the session being contained in a distinct domain, and wherein each plane represents a collection of media aware network entities partaking on a subset of topics within the domain,
a complementary subset of planes common to all participating media network entities of a domain,
an aggregation of domains and topics, and
a method for addressing namespaces within the topics; and
exchanging one or more data streams in a session between a first media aware network entity and a second media aware network entity in the computer network in accordance with the communication model.

2. The method of claim 1, wherein:
several sessions are simultaneously present in the computer network and a distinct set of media aware network entities is associated with each session;
each session is associated with a distinct subset of media planes, control planes and administration planes; and
wherein the complimentary subset of planes includes a domain administration plane that is common to all participating media aware network entities of a domain.

3. The method of claim 2, wherein the one or more data streams are supported by the media plane and are managed as topics to which a data reader can subscribe.

4. The method of claim 2, wherein the domain administration plane includes a topic containing presence information.

5. The method of claim 2, wherein an administration plane is associated with each session and a domain administration plane is shared between all media aware network entities of a domain.

6. The method of claim 1, wherein one session maps to a single domain.

7. The method of claim 1, wherein a domain contains multiple independent sessions.

8. The method of claim 2, wherein there is one media plane per media component per media aware network entity publishing in a session.

9. The method of claim 2, wherein there is one media plane per media aware network entity publishing in the session, the media plane containing all the media components published by the media aware network entity.

10. The method of clam 2, wherein there is one media plane for all components for all media aware network entities publishing in a session.

11. The method of claim 1, further comprising:
providing a topic nomenclature and namespace rules to each media aware network entity joining a session, wherein the topic nomenclature and namespace rules characterize the planes in the subset of planes associated with the session and the planes in the complementary subset of planes.

12. The method of claim 11, wherein the topic nomenclature and namespace rules include a first portion and a second portion, and further comprising:
using the first portion of the topic nomenclature and namespace rules, by the media aware network entities joining a session, to exchange information about the second part of the topic nomenclature and namespace rules with other media aware network entities joining the session.

13. The method of claim 12, wherein the first portion includes the complementary subset of planes.

14. The method of claim 12, wherein the first portion of the topic nomenclature and namespace rules is hardcoded in the media aware network entity logic.

15. The method of claim 12, wherein the first portion of the topic nomenclature and namespace rules is provided and updated by a supervisory central service.

16. The method of claim 11, wherein the topic nomenclature and the namespace rules are hardcoded in the media aware network entity logic.

17. The method of claim 11, wherein the topic nomenclature and the namespace rules are provided by a supervisory central service.

18. The method of claim 11, wherein providing topic nomenclature and namespace rules includes:
accessing, by each media aware network entity joining a session, the topic nomenclature and namespace rules using a hardcoded topic in a plane known to the media aware network entities.

19. The method of claim 11, further comprising:
updating the topic nomenclature and namespace rules to define a different configuration of planes in the subset of planes associated with the session and a different configuration of planes in the complementary subset of planes.

20. The method of claim 11, wherein two simultaneous sessions in a same domain have different plane arrangements, the plane arrangement for each session being defined by a distinct set of topic nomenclature and namespace rules.

21. A computer-implemented method for distributing a data stream in a computer network, comprising:
providing a computer network, the computer network including a plurality of interconnected media aware network entities in a publish-subscribe framework, wherein one or more of the media aware network entities include a plurality of data writers and a plurality of data readers;
publishing the data stream by the plurality of data writers in a first media aware network entity, wherein each data writer among the plurality of data writers in the first media aware network entity is operable to publish a specific layer of the data stream; and
subscribing, by a data reader in a second media aware network entity, to the data stream published by one or more of the data writers among the plurality of data writers in the first media aware network entity.

22. The method of claim 21, wherein the media aware network entities further include logic for one or more of: network adaptation, data stream transformation, and data stream recording.

23. The method of claim 22, further comprising:
transforming by a media aware network entity the incoming data stream from the first media aware network entity from a first format to a second format; and
retransmitting the data stream in the second format to a different media aware network entity.

24. The method of claim 23, wherein transforming the incoming data stream includes one or more of: transcoding from a first protocol to a second protocol, translating from text to speech, transcoding from a first format to a second format, translating from speech to text, translating from a first language to a second language, extracting metadata from the data stream for use in a different media aware network entity.

25. The method of claim 22, further comprising:
recording by a media aware network entity the incoming data stream from the first media aware network entity for future processing or storage.

26. The method of claim 25, further comprising:
playing back, by a media aware network entity, the recorded data stream.

27. The method of claim 21, further comprising:
customizing the media aware network entities based on one or more of: network topology, location, and hardware capability.

28. The method of claim 21, wherein the data stream includes data representing one or more of: video, audio, chat, financial market data, radar data, telemetry, telecommands, teleprescence data, haptics measurements, and telemedicine data.

29. The method of claim 21 wherein:
each data writer in a first media aware network entity publishes its layer of the data stream in a media plane among a plurality of planes that are associated with a session between the first and second media aware network entities; and
the data reader in the second media aware network entity subscribes to a subset of media planes, which subset collectively defines a quality of the data stream to which the second media aware network desires to subscribe.

30. The method of claim 29, wherein each media plane contains data published by two or more data writers.

31. The method of claim 29, wherein each media plane contains one or more topics to which the data reader can subscribe.

32. The method of claim 29, wherein each data writer in a media plane corresponds to one media aware network entity.

33. The method of claim 21, further comprising:
detecting by the data reader in the second media aware network entity whether there are irregularities in the data stream sent from the data writer in the first media aware network entity; and
in response to detecting irregularities or improved network conditions, subscribing to a different subset of data writers among the plurality of data writers in the first media aware network entity.

34. The method of claim 33, wherein detecting the irregularities includes one or more of:
detecting data packets in the data stream that arrive at the data reader in a different order compared to the order in which the data packets were transmitted by the data writer, and
detecting lost data packets in the data stream received by the data reader.

35. The method of claim 33, wherein detecting improved network conditions includes:
detecting decrease in rate of lost or corrupted data packets.

36. The method of claim 33, further comprising:
in response to detecting irregularities in the data stream:
discarding invalid or redundant data packets;
renumbering the received data packets; and
transmitting the renumbered data packets to a data reader of a different media aware network entity.

37. The method of claim 33, wherein the data stream is a video stream, and subscribing to a different subset of data writers starts when irregularities in the video stream has been detected during a time window that is based on one or more of: a video frame rate for the video stream, and a video slice period for packets in the video stream.

38. A computer program product for organizing a communication session between two or more media aware network entities in a computer network, the computer program product comprising:
a computer readable storage medium having computer readable program code embodied therewith, the computer readable program code comprising:
computer readable program code configured to provide a plurality of media aware network entities in a computer network, wherein one or more of the media aware network entities includes a plurality of data writers and a plurality of data readers;
computer readable program code configured to provide a communication model for communication between the media aware network entities, the communication model including:
a plurality of subsets of planes, wherein each subset of planes is associated with a session between two or more media aware network entities, the session being contained in a distinct domain, and wherein each plane represents a collection of media aware network entities partaking on a subset of topics within the domain,
a complementary subset of planes common to all participating media network entities of a domain,
an aggregation of domains and topics, and
a method for addressing namespaces within the topics; and
computer readable program code configured to exchange one or more data streams in a session between a first media aware network entity and a second media aware network entity in the computer network in accordance with the communication model.

39. The computer program product of claim 38, wherein:
several sessions are simultaneously present in the computer network and a distinct set of media aware network entities is associated with each session;
each session is associated with a distinct subset of media planes, control planes and administration planes; and
wherein the complimentary subset of planes includes a domain administration plane that is common to all participating media aware network entities of a domain.

40. The computer program product of claim 38, further comprising:
computer readable program code configured to provide a topic nomenclature and namespace rules to each media aware network entity joining a session, wherein the topic nomenclature and namespace rules characterize the planes in the subset of planes associated with the session and the planes in the complementary subset of planes.

41. A computer program product for distributing a data stream in a computer network, the computer program product comprising:
a computer readable storage medium having computer readable program code embodied therewith, the computer readable program code comprising:
computer readable program code configured to provide a plurality of interconnected media aware network entities in a publish-subscribe framework implemented in a computer network, wherein one or more of the media aware network entities include a plurality of data writers and a plurality of data readers;
computer readable program code configured to publish the data stream by the plurality of data writers in a first media aware network entity, wherein each data writer among the plurality of data writers in the first media aware network entity is operable to publish a specific layer of the data stream; and
computer readable program code configured to subscribe, by a data reader in a second media aware network entity, to the data stream published by one or more of the data writers among the plurality of data writers in the first media aware network entity.

42. The computer program product of claim 41, further comprising:
computer readable program code configured to cause a data reader in the second media aware network entity to detect whether there are irregularities in the data stream sent from the data writer in the first media aware network entity; and
computer readable program code configured to cause the data reader in the second media aware network entity to subscribe to a different subset of data writers among the plurality of data writers in the first media aware network entity in response to detecting irregularities or improved network conditions.
